(19) United States
(12) Patent Application Publication
(10) Pub. No.: US 2024/0127033 A1
(43) Pub. Date: Apr. 18, 2024

(54) PROCESSORS AND METHODS FOR GENERATING A PREDICTION VALUE OF A NEURAL NETWORK

(71) Applicant: HUAWEI CLOUD COMPUTING TECHNOLOGIES CO., LTD., Guizhou (CN)

(72) Inventors: Morgan Lindsay HEISLER, Burnaby (CA); Amin BANITALEBI DEHKORDI, Vancouver (CA); Yong ZHANG, Richmond (CA)

(21) Appl. No.: 17/965,304

(22) Filed: Oct. 13, 2022

(51) Int. Cl. G06N 3/04; G06K 9/62

(52) U.S. Cl. CPC G06N 3/0454; G06K 9/6263

(57) ABSTRACT

Methods and systems for generating a prediction value of a Neural Network (NN). The method is executable by a processor and comprises generating, by the processor employing a feature extraction sub-network, a plurality of features based on an input object, generating, by the processor employing a detection sub-network, a detection output based on the plurality of features, the detection sub-network having been trained to generate the detection output indicative of a human-interpretable output for a given portion of the input object; generating, by the processor employing a prediction sub-network, the prediction value based on the human-interpretable output and the given portion of the input object; and providing, by the processor, an indication of the prediction value and the human-interpretable output via a user interface.

### FIELD OF THE TECHNOLOGY

The present technology relates to Neural Networks (NNs). In particular, methods and processors for generating a prediction value of a NN associated with a human-interpretable output are disclosed.

### BACKGROUND

Machine Learning Algorithms (MLAs) have recently gained traction in a wide range of applications. Typical end-to-end MLAs provide a user with an output generated based on one or more inputs. Although there are several methods that perform post-hoc analysis of the information learned by intermediate layers in MLAs, said typical end-to-end MLAs are usually referred to as “black boxes” that operate multiple computing components, which make it difficult for a user to interact with, manage and/or monitor inference of a given MLA. Besides, typical MLAs do not provide information that will naturally align with human concepts during inference time of the MLAs.

Therefore, there is a desire for MLAs that generate a prediction value from an inference process that a user may interact with, manage and/or monitor.

### SUMMARY

Developers have realized that when decisions need to be made based on machine learning outputs, it is often useful to explain the output in terms of intermediate concepts that are “human-interpretable”. For example, a radiologist using an MLA to grade severity of knee osteoarthritis may wish to frame a diagnosis in terms of concepts such as “bone spurs” and “sclerosis”. It would be natural, for example, for such a user to wonder if the space between the knee joints was too narrow or want to be able to correct the MLA if the MLA erroneously predicted a bone spur and see how the output of the MLA is adjusted accordingly.

Embodiments of the present technology have been developed based on developers' appreciation of shortcomings associated with the prior art. More specifically, it is believed that providing human-interpretable outputs along with the prediction values inferred by an MLA may increase in a sense “trust” of the user in the MLA and the prediction values. It can be thus said that the MLA may provide reasons for a given prediction to the user.

Generally speaking, Concept Bottleneck Networks (CBNs) may be used to map an input object onto concepts, and further map those concepts into a prediction value (or a plurality of prediction values). Developers of the present technology have realized that some MLAs that incorporate such Concept Learning Networks (CLNs) have been shown to match the performance of complex black-box prediction models while having the ability to explain decisions based on human understandable concepts.

However, developers of the present technology have also realized that a desirable property of concepts is to depend on the relevant parts of the input object or, more generally, of the input space. For example, a “brain tumour” concept should correspond to the brain region on a full-body MRI. Developers have realized that prior-art CBNs are not designed to make predictions for specific parts of input images. In other words, concepts in conventional solutions do not correspond to anything semantically meaningful in input space. Thus, interpretation of the downstream prediction may be misleading for the user.

Developers have also realized that the outputs of the conventional CLNs encode more than information about the concepts only. This renders interpretations of downstream models built on these CLNs unreliable. Indeed, it may be difficult to isolate individual influence of a concept found in the image being analyzed when the concept representation rendered by the outputs of the CLN contains additional information.

Broadly speaking, at least some embodiments of the present technology aim to address drawbacks found in the prior art by conditioning the concept learning network on the portion of the input object that contains a concept (e.g., a given location of the concept in the input object). Moreover, the user intervention may occur at different instances of a pipeline of the end-to-end MLA. This may allow for intervention on both the concept classification and location, and provides more interpretability to the end-user.

In a first broad aspect of the present technology, there is provided a method of generating a prediction value of a Neural Network (NN), the method executable by a processor. The method comprises generating, by the processor employing a feature extraction sub-network, a plurality of features based on an input object; generating, by the processor employing a detection sub-network, a detection output based on the plurality of features, the detection sub-network having been trained to generate the detection output indicative of a human-interpretable output for a given portion of the input object; generating, by the processor employing a prediction sub-network (e.g. a first prediction sub-network), the prediction value (e.g. a first prediction value) based on the human-interpretable output and the given portion of the input object; and providing, by the processor, an indication of the prediction value and the human-interpretable output via a user interface.

In some embodiments, the method further comprises providing, by the processor, an indication of the given portion of the input object to the user interface, in addition to the prediction value and the human-interpretable output.

In some embodiments, the method further comprises generating, by the processor employing an other prediction sub-network (e.g. a second prediction sub-network), an other prediction value (e.g. a second prediction value) based on the plurality of features; and providing, by the processor, an indication of the other prediction value to the user interface, in addition to the prediction value and the human-interpretable output.

In some embodiments, the feature extracting sub-network is a Convolutional Neural Network (CNN).

In some embodiments, the prediction sub-network is at least one of a classification sub-network and a regression sub-network.

In some embodiments, the method further comprises receiving, by the processor, an indication of a modified portion of the input object from the user interface, the modified portion being different from the given portion; generating, by the processor employing the detection sub-network, a modified detection output being indicative of an other human-interpretable output for the modified portion, the other human-interpretable output being different from the human-interpretable output; generating, by the processor employing the prediction sub-network, an other prediction value based on the other human-interpretable output and the modified portion; and providing, by the processor, an indication of the other prediction value and of the other human-interpretable output to the user interface.

In some embodiments, the method further comprises receiving, by the processor, an indication of a modified human-interpretable output from the user interface for the given portion; generating, by the processor employing the prediction sub-network, an other prediction value based on the modified human-interpretable output and the portion of the input object; and providing, by the processor, an indication of the other prediction value and of the modified human-interpretable output to the user interface.

In some embodiments, the detection sub-network includes a Location Learning Network (LLN) and a Concept Learning Network (CLN). Generating the detection output comprises determining, by the processor employing the LLN, a location of the given portion in the input object based on the plurality of features; and generating, by the processor employing the CLN, the human-interpretable output based on the location of the given portion and the plurality of features.

In some embodiments, the method further comprises receiving, by the processor, an indication of a modified portion of the input object from the user interface, the modified portion being associated with a modified location in the input object, the modified location being different from the location of the given portion; generating, by the processor employing the CLN, an other human-interpretable output based on the modified portion and the plurality of features; generating, by the processor employing the prediction sub-network, an other prediction value based on the other human-interpretable output and the modified portion; and providing, by the processor, an indication of the other prediction value and of the other human-interpretable output to the user interface.

In some embodiments, the input object is at least one of: an image file, an audio file, and a video file.

In some embodiments, the human-interpretable output is for enabling a user of the processor to evaluate accuracy of the prediction value.

In a second broad aspect of the present technology, there is provided a system for generating a prediction value of a Neural Network (NN), the system comprising a processor and a memory, the memory comprising instructions which, upon being executed by the processor, cause the processor to generate, by employing a feature extraction sub-network, a plurality of features based on an input object; generate, by employing a detection sub-network, a detection output based on the plurality of features, the detection sub-network having been trained to generate the detection output indicative of a human-interpretable output for a given portion of the input object; generate, by employing a prediction sub-network, the prediction value based on the human-interpretable output and the given portion of the input object; and provide an indication of the prediction value and the human-interpretable output via a user interface.

In some embodiments, the processor is further configured to provide an indication of the given portion of the input object to the user interface, in addition to the prediction value and the human-interpretable output.

In some embodiments, the processor is further configured to generate, by employing an other prediction sub-network, an other prediction value based on the plurality of features; and provide an indication of the other prediction value to the user interface, in addition to the prediction value and the human-interpretable output.

In some embodiments, the feature extracting sub-network is a Convolutional Neural Network (CNN).

In some embodiments, the prediction sub-network is at least one of a classification sub-network and a regression sub-network.

In some embodiments, the processor is further configured to receive an indication of a modified portion of the input object from the user interface, the modified portion being different from the given portion; generate, by employing the detection sub-network, a modified detection output being indicative of an other human-interpretable output for the modified portion, the other human-interpretable output being different from the human-interpretable output; generate, by employing the prediction sub-network, an other prediction value based on the other human-interpretable output and the modified portion; and provide an indication of the other prediction value and of the other human-interpretable output to the user interface.

In some embodiments, the processor is further configured to receive an indication of a modified human-interpretable output from the user interface for the given portion; generate, by employing the prediction sub-network, an other prediction value based on the modified human-interpretable output and the portion of the input object; and provide an indication of the other prediction value and of the modified human-interpretable output to the user interface.

In some embodiments, the detection sub-network includes a Location Learning Network (LLN) and a Concept Learning Network (CLN), and the processor is further configured to, in order to generate the detection output, determine, by employing the LLN, a location of the given portion in the input object based on the plurality of features; and generate, by employing the CLN, the human-interpretable output based on the location of the given portion and the plurality of features.

In some embodiments, the processor is further configured to receive an indication of a modified portion of the input object from the user interface, the modified portion being associated with a modified location in the input object, the modified location being different from the location of the given portion; generate, by employing the CLN, an other human-interpretable output based on the modified portion and the plurality of features; generate, by employing the prediction sub-network, an other prediction value based on the other human-interpretable output and the modified portion; and provide an indication of the other prediction value and of the other human-interpretable output to the user interface.

In some embodiments, the input object is at least one of: an image file, an audio file, and a video file.

In some embodiments, the human-interpretable output is for enabling a user of the processor to evaluate accuracy of the prediction value.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “user device” is any computer hardware that is capable of running software appropriate to the relevant task at hand. Thus, some (non-limiting) examples of user devices include personal computers (desktops, laptops, netbooks, etc.), smartphones, and tablets, as well as network equipment such as routers, switches, and gateways. It should be noted that a device acting as a user device in the present context is not precluded from acting as a server to other user devices. The use of the expression “a user device” does not preclude multiple user devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context), firmware, hardware, or a combination thereof, that is both necessary and sufficient to achieve the specific function(s) being referenced.

In the context of the present specification, the expression “computer usable information storage medium” or “computer-readable medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic representation of a user device configured for communicating with a data management system in accordance with an embodiment of the present technology;

FIG. 2 is a block-diagram of an execution pipeline of an MLA by the user device of FIG. 1 in accordance with an embodiment of the present technology;

FIG. 3 is a block-diagram of an execution pipeline of an MLA by the user device of FIG. 1 in accordance with another embodiment of the present technology;

FIG. 4 is a block-diagram of an execution pipeline of an MLA by the user device of FIG. 1 in accordance with yet another embodiment of the present technology;

FIG. 5 is a flow diagram showing operations of a method for generating a prediction value of a Neural Network in accordance with some embodiments of the present technology;

FIG. 6A is a schematic representation of a user interface of the user device of FIG. 1 providing information about a prediction output and an associated human-interpretable output in accordance with yet another embodiment of the present technology; and

FIG. 6B is a schematic representation of the user interface of FIG. 6A providing information about a prediction output and a human-interpretable output following adjustment instructions.

It should also be noted that, unless otherwise explicitly specified herein, the drawings are not to scale.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements that, although not explicitly described or shown herein, nonetheless embody the principles of the present technology.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagram herein represents conceptual views of illustrative circuitry embodying the principles of the present technology. Similarly, it will be appreciated that any flowcharts, flow diagrams, state transition diagrams, pseudo-code, and the like represent various processes that may be substantially represented in non-transitory computer-readable media and so executed by a computer or processor, whether or not such computer or processor is explicitly shown.

The functions of the various elements shown in the figures, including any functional block labeled as a “processor” or “processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

In the context of the present disclosure, the terms “neural network” (NN) and “Machine learning algorithm” (MLA) both refers to a same algorithm generating inferences using a neural network-based architecture. More specifically, the MLA may include an NN, such that execution of the MLA corresponds to an execution of the corresponding NN.

With these fundamentals in place, we will now consider some non-limiting examples to illustrate various implementations of aspects of the present technology.

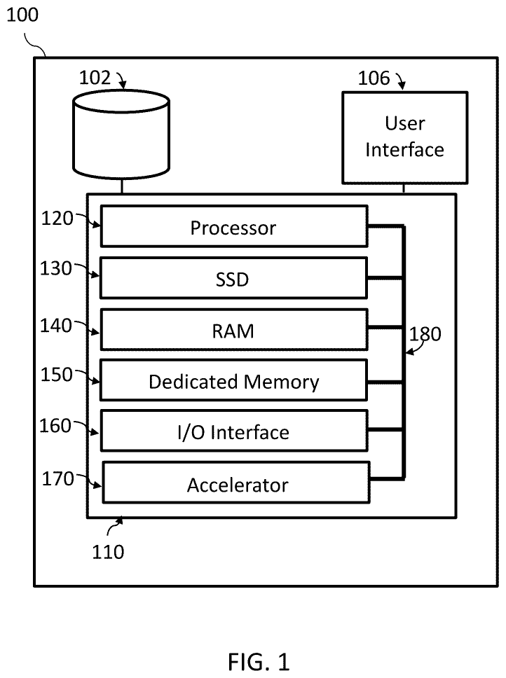

Referring to FIG. 1, there is shown a schematic diagram of a system 100, the system 100 being suitable for implementing non-limiting embodiments of the present technology. It is to be expressly understood that the system 100 as depicted is merely an illustrative implementation of the present technology. Thus, the description thereof that follows is intended to be only a description of illustrative examples of the present technology. This description is not intended to define the scope or set forth the bounds of the present technology. In some cases, what is believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 100 may provide in certain instances simple implementations of the present technology, and that where such is the case they have been presented in this manner as an aid to understanding. As persons skilled in the art would understand, various implementations of the present technology may be of a greater complexity.

Generally speaking, the system 100 executes machine learning algorithms (MLAs) and generates a prediction value of neural networks (NNs) of the MLAs, the system providing an indication of a prediction value generated by the NNs and an associated human-interpretable output to a user of the system 100. As such, the system 100 may be referred to as a user device 100. Indeed, as will be described in greater details herein after, the user device 100 may be associated with a user desiring to use outputs provided by MLAs that may be executed by the user device 100. For example, the user may seek to execute an MLA and be provided with a prediction value inferred by the MLA for a given input data, and a human-interpretable output associated with the prediction value. As the skilled person would understand, the human-interpretable output may provide the user with an understanding of the inference process of the MLA. As will be described in greater details, the user may cause adjustment of the inference of the MLA by reviewing the human-interpretable output and adjusting inference of the MLA.

With reference to FIG. 1, is a schematic representation of the user device 100 in accordance with an embodiment of the present technology. The user device 100 comprises a computing unit 110. In some embodiments, the computing unit 110 may be implemented by any of a conventional personal computer, a controller, and/or an electronic device (e.g., a server, a controller unit, a control device, a monitoring device etc.) and/or any combination thereof appropriate to the relevant task at hand. In some embodiments, the computing unit 110 comprises various hardware components including one or more single or multi-core processors collectively represented by a processor 120, a solid-state drive 130, a RAM 140, a dedicated memory 150 and an input/output interface 160. The computing unit 110 may be a generic computer system.

In some other embodiments, the computing unit 110 may be an “off the shelf” generic computer system. In some embodiments, the computing unit 110 may also be distributed amongst multiple systems. The computing unit 110 may also be specifically dedicated to the implementation of the present technology. As a person in the art of the present technology may appreciate, multiple variations as to how the computing unit 110 is implemented may be envisioned without departing from the scope of the present technology.

Communication between the various components of the computing unit 110 may be enabled by one or more internal and/or external buses 180 (e.g. a PCI bus, universal serial bus, IEEE 1394 “Firewire” bus, SCSI bus, Serial-ATA bus, ARINC bus, etc.), to which the various hardware components are electronically coupled.

The input/output interface 160 may provide networking capabilities such as wired or wireless access. As an example, the input/output interface 160 may comprise a networking interface such as, but not limited to, one or more network ports, one or more network sockets, one or more network interface controllers and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to implementations of the present technology, the solid-state drive 130 stores program instructions suitable for being loaded into the RAM 140 and executed by the processor 120. Although illustrated as a solid-state drive 130, any type of memory may be used in place of the solid-state drive 130, such as a hard disk, optical disk, and/or removable storage media.

The processor 120 may be a general-purpose processor, such as a central processing unit (CPU) or a processor dedicated to a specific purpose, such as a digital signal processor (DSP). In some embodiments, the processor 120 may also rely on an accelerator 170 dedicated to certain given tasks. In some embodiments, the processor 120 or the accelerator 170 may be implemented as one or more field programmable gate arrays (FPGAs). Moreover, explicit use of the term “processor”, should not be construed to refer exclusively to hardware capable of executing software, and may implicitly include, without limitation, application specific integrated circuit (ASIC), read-only memory (ROM) for storing software, RAM, and non-volatile storage. Other hardware, conventional and/or custom, may also be included.

Further, the user device 100 includes a Human-Machine Interface (HMI) 106. The HMI 106 may include a screen or a display capable of rendering an interface including outputs of the executed MLA, predictions and human-interpretable outputs. In this embodiment, the display of the HMI 106 includes and/or be housed with a touchscreen to permit users to input data via some combination of virtual keyboards, icons, menus, or other Graphical User Interfaces (GUIs). The HMI 106 may thus be referred to as a user interface 106. In some embodiments, the display of the user interface 106 may be implemented using a Liquid Crystal Display (LCD) display or a Light Emitting Diode (LED) display, such as an Organic LED (OLED) display. The device may be, for example and without being limitative, a handheld computer, a personal digital assistant, a cellular phone, a network device, a smartphone, a navigation device, an e-mail device, a game console, or a combination of two or more of these data processing devices or other data processing devices. The user interface 106 may be embedded in the user device 100 as in the illustrated embodiment of FIG. 1 or located in an external physical location accessible to the user. For example, the user may communicate with the computing unit 110 (i.e. send instructions thereto and receive information therefrom) by using the user interface 106 wirelessly connected to the computing unit 110. The computing unit 110 may be communicate with the user interface 106 via a network (not shown) such as a Local Area Network (LAN) and/or a wireless connexion such as a Wireless Local Area Network (WLAN).

The user device 100 may comprise a memory 102 communicably connected to the computing unit 110 for storing outputs of the MLAs for example, and/or history of execution of the MLA. The memory 102 may be embedded in the user device 100 as in the illustrated embodiment of FIG. 1 or located in an external physical location. The computing unit 110 may be configured to access a content of the memory 102 via a network (not shown) such as a Local Area Network (LAN) and/or a wireless connexion such as a Wireless Local Area Network (WLAN).

The user device 100 may also include a power system (not depicted) for powering the various components. The power system may include a power management system, one or more power sources (e.g., battery, alternating current (AC)), a recharging system, a power failure detection circuit, a power converter or inverter and any other components associated with the generation, management and distribution of power in mobile or non-mobile devices.

Generally speaking, the user device 100 is configured to (i) execute one or more MLAs, (ii) provide the user with human-interpretable outputs and predictions values generated by the MLAs, (iii) receive user instructions from the user through the user interface 106, and (iv) execute the one or more MLAs based on the received instructions. Implementations and examples of user instructions are described in greater details herein after. It should be noted that functions of the user device 100 described herein may be provided by a single dedicated processor, by a single shared computing component, or by a plurality of individual computing components, some of which may be shared. For example, the user device 100 may be communicatively connected to a server that executes the one or more MLAs, the user device 100 being thus used as an access point by the user to access and use computing resources of the server.

It should be noted that the computing unit 110 may be implemented as a conventional computer server or cloud-based (or on-demand) environment. Needless to say, the computing unit 110 may be implemented in any other suitable hardware, software, and/or firmware, or a combination thereof. In the depicted non-limiting embodiments of the present technology in FIG. 1, the computing unit 110 is a single server. In alternative non-limiting embodiments of the present technology, the functionality of the computing unit 110 may be distributed and may be implemented via multiple servers.

Those skilled in the art will appreciate that processor 120 is generally representative of a processing capability that may be provided by, for example, a Central Processing Unit (CPU). In some embodiments, in place of or in addition to one or more conventional CPUs, one or more specialized processing cores may be provided. For example, one or more Graphic Processing Units (GPUs), Tensor Processing Units (TPUs), accelerated processors (or processing accelerators) and/or any other processing unit suitable for training and executing an MLA may be provided in addition to or in place of one or more CPUs. In this embodiment, the processing unit 120 of the computing unit 110 is a Graphical Processing Unit (GPU) and the dedicated memory 140 is a Video Random access Memory (VRAM) of the processing unit 120. In alternative embodiments, the dedicated memory 140 may be a Random Access Memory (RAM), a Video Random Access Memory (VRAM), a Window Random Access Memory (WRAM), a Multibank Dynamic Random Access Memory (MDRAM), a Double Data Rate (DDR) memory, a Graphics Double Data Rate (GDDR) memory, a High Bandwidth Memory (HBM), a Fast-Cycle Random-Access Memory (FCRAM) or any other suitable type of computer memory.

The MLAs that may be executed by the user device 100, and more specifically by the computing unit 110 may be, for example and without limitations, forecasting (e.g. weather forecasting, traffic forecasting) algorithms, image recognition algorithms and natural language processing algorithms (e.g. textual and/or speech recognition and translation). For example and without limitation, a given MLA may pertain to one of the following applications:
Medical applications: Allowing users (e.g. doctors) to see which high-level concepts are used by the MLA for disease diagnosis, prognosis, etc. and intervene if necessary;
Judicial applications: Allowing users (e.g. judges) to see on what grounds a defendant is found innocent/guilty and intervene if necessary;
Autonomous driving: Allowing users (e.g. drivers) to see which high-level concepts (driving conditions such as weather and construction, driving rules such as speed limits and parking restrictions, etc.) are being used to determine the car's behavior and intervene if necessary; and
Sales applications: Allowing user (e.g. sellers) to identify which features of an item drives down the list price and/or to be able to correct an auto-generated sale listing of an item for online sales.

At least some of the MLAs that can be executed by the user device 100 may be already trained, and at least some of these MLAs of the may be untrained or partially trained.

Non limitative examples of MLAs that can be executed by the user device 100 may include non-linear algorithm, linear regression, logistic regression, decision tree, support vector machine, naïve bayes, K-nearest neighbors, K-means, random forest, dimensionality reduction, neural network, gradient boosting, adaboost, lasso, elastic net, ridge, bayesian ridge, Automatic Relevance Determination (ARD) regression, Stochastic Gradient Descent (SGD) regressor, passive aggressive regressor, k-neighbors regressor and/or Support Vector Regression (SVR). Other MLAs may also be envisioned without departing from the scope of the present technology. A structure of the MLA is described in greater details herein below.

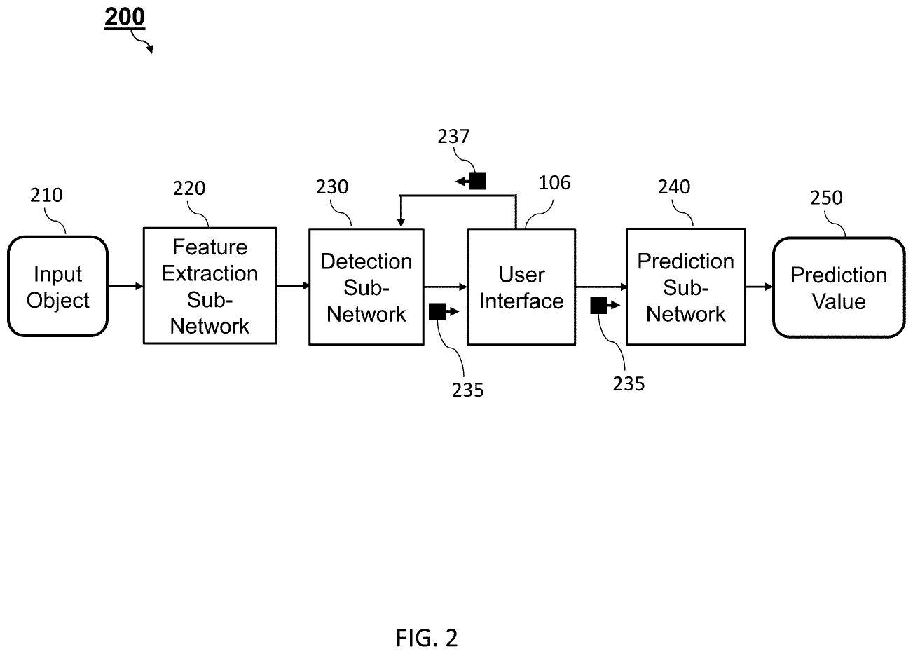

FIG. 2 is a block-diagram of an execution pipeline 200 of an MLA by the user device 100 in accordance with an embodiment of the present technology. In this embodiment, the MLA includes a Feature Extraction Sub-Network (FESN) 220, a Detection Sub-Network (DSN) 230 and a Prediction Sub-Network (PSN) 240.

In use, an input object 210 is received by the FESN 220 that is implemented as a Convolutional Neural Network (CNN) in this embodiment. The input object 210 may be an image file (e.g. under PNG, JPG, or any other image format), an audio file (e.g. under PCM, MP3, WAV, or any other suitable audio format), or a video file (e.g. under AVI, MOV, WMV, or any other suitable video format). The following examples set forth in the present disclosure are related to a scenario where the input object 210 is an image file. However, this should not be understood as a limitation of the present technology, but rather as a mere illustration of applications of the present technology.

Once the FESN 220 has received the input object 210, the FESN 220 generates a plurality of features extracted from the input object 210. The FESN 220 may thus be referred to as a “backbone” of the MLA. For example, in the scenario where the input object is a radio image of a knee, the FESN 220 may generate features such as a size of kneecap or a length of a set of tendons. The FESN 220 may rely on object detection algorithms to generate said plurality of features.

The plurality of features is further transmitted from the FESN 220 to the DSN 230. In this embodiment, the DSN 230 is implemented as a Concept Detection Network (CDN) and generates a detection output 235. The DSN 230 has been trained such that the detection output 235 is indicative of a human-interpretable output for a given portion of the input object. The human-interpretable output may include information about one or more pre-determined concepts, and information about one or more locations of said pre-determined concepts on the input object 210. The pre-determined concepts are thus associated with given portions of the input object 210. For example, the pre-determined concepts for the radio image of a knee may be sclerosis, bone spurs, narrow joint space, or any other concepts. Each pre-determined concept may be attributed with a numerical value (e.g. from 0 to 1) representative of a level or presence of the corresponding pre-determined concept in the input object 210. For example, numerical value associated with the “sclerosis” pre-determined concept may be 0.27, and numerical value associated with the “bone spurs” pre-determined concept may be 0.9.

The DSN 230 may use a region proposal network and region of interest (ROI) pooling to generate the detection output 235. More specifically, the region proposal network and the ROI pooling are used to determine presence of the pre-determined concepts and locations of the pre-determined concepts. In this example, information about the locations of the pre-determined concepts is represented under the form of bounding boxes and/or masks. It can be said that the DSN 230 maps the features into the one or more concepts that are human-interpretable.

In this embodiment, the detection output 235 is provided to the user through, for example, the user interface 106 of the user device 100 before being transmitted to the PSN 240. As such, the user is provided with information about an inference process of the MLA and more specifically, with information about the pre-determined concepts mapped by the DSN 230 (e.g. numerical values and bounding boxes associated therewith). More specifically, the user may be provided with an indication of the given portion (e.g. a location of a pre-determined concept mapped by the DSN 230) of the input object 210, in addition to the prediction value and the human-interpretable output associated with the detection output 235.

In the same or other embodiments, the user intervenes through the user interface 106 to generate an adjustment instruction 237 by adjusting the detection output 235. For example, the user may adjust locations of some of the pre-determined concepts and numerical values associated therewith. In use, the adjustment instruction 237 is transmitted back to the DSN 230 instead of the detection output 235 being transmitted to the PSN 240. In this scenario, the DSN 230 generates a modified detection output based on the adjustment instruction 237. It can thus be said that the user adjusts positions and levels of presence of the pre-determined concept by providing the adjustment instruction 237 to the DSN 230. Summarily, the detection output 235 is transmitted from the DSN 230 to the PSN 240, and, in response to the user intervening and generating the adjustment instruction 237, the modified detection output is transmitted to the PSN 240 instead of the detection output 235.

In the scenario where the detection output 235 is transmitted to the PSN 240, the PSN generates a prediction value 250 based on the detection output 235, the prediction value 250 being an output of the MLA. More specifically, the PSN 240 generates the predication value 250 based on the human-interpretable output (e.g. information about the pre-determined concepts) associated with the detection output 235, and the corresponding given portion of the input object 210 (e.g. locations of the pre-determined concepts).

In the scenario where the modified detection output is transmitted to the PSN 240, the PSN generates the prediction value 250 based on the modified detection output. More specifically, the PSN 240 generates the predication value 250 based on the human-interpretable output (e.g. information about the pre-determined concepts) associated with the modified detection output, and the corresponding given portion of the input object 210 (e.g. adjusted locations of the pre-determined concepts). In this embodiment, the PSN 240 is at least one of a classification sub-network and a regression sub-network.

The user may thus be provided with the prediction value 250 along with the human-interpretable output, the human-interpretable output enabling the user to evaluate accuracy of the prediction value 250.

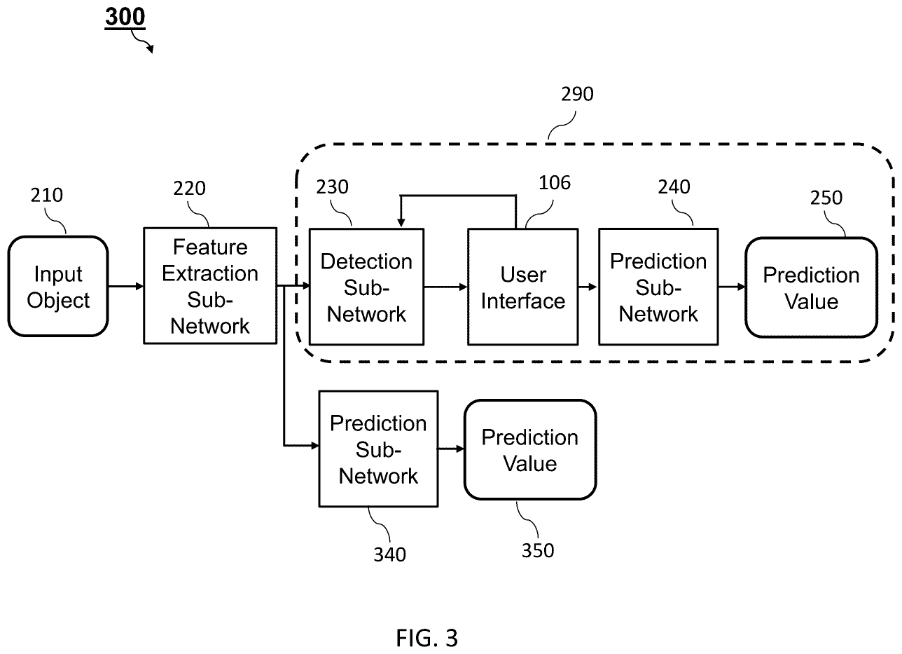

FIG. 3 is a block-diagram of an execution pipeline 300 of an MLA by the user device 100 in accordance with another embodiment of the present technology. The pipeline 300 includes at least some of the components of the pipeline 200 that are thus referred to using the same reference number. Only components of the pipeline 300 that are not included in the pipeline 200 are described here below.

In this embodiment, the pipeline 300 further includes a second PSN 340. In use, the FESN 220 transmits the plurality of features extracted from the input object 210 to the PSN 340, the PSN 340 having been trained to generate a prediction value 350 based on a plurality of features. The pipeline 300 thus generates two prediction values 250, 350, the prediction value 250 being generated from the pipeline 200, and the prediction value 350 being generated by the combination of the FESB 220 and the PSN 340. In use, the prediction values 350 may be compared to the prediction value 250, the prediction value 250 being used as a reference label for the prediction value 350.

It should be noted that the combination of the FESB 220 with the PSN 340 may be a previously trained network, also referred to as a “supermodel”. Portion 290 of the pipeline 300 includes components of the pipeline 200. It can thus be said that the present technology may be implemented on any previously trained network by implementing the portion 290. As such, comparing the prediction values 250, 350 may harness pre-trained weights of the supermodel. This additionally allows for the accuracy of a supermodel, as well as the interpretability of a concept network.

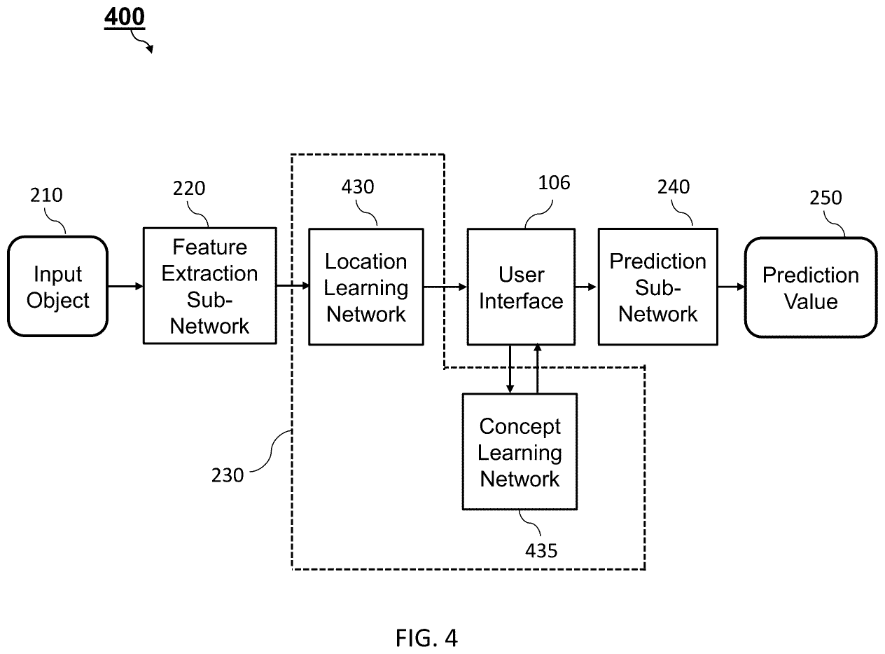

FIG. 4 is a block-diagram of an execution pipeline 400 of an MLA by the user device 100 in accordance with yet another embodiment of the present technology. The pipeline 400 includes at least some of the components of the pipeline 200 that are thus referred to using the same reference number. Only components of the pipeline 400 that are not included in the pipeline 200 are described here below.

In the pipeline 400, the DSN 230 includes a Location Learning Network (LLN) 430 for receiving the plurality of extracted features from the FESN 220. In this embodiment, the LLN 430 is employed to determine a location of a given portion of the input object 210 based on the plurality of features. For example, the input object 210 may be an image of a bird, and the MLA is executed by a user desiring to know which species of bird it is. The pre-determined concepts used by the MLA may be for example a wing color, a wing size and a wing shape. Instead of having to determine levels of presence of those pre-determined concepts on the entire image, it may be desirable to narrow the detection of pre-determined concepts to the bird's wing only to decrease probability of faulty detection and reduce an inference time of the MLA.

In use, for a given pre-determined concept, the LLN 430 determines a location of a given portion in the input object 210 based on the plurality of extracted features. The LLN 430 may have been trained to determine location of portions of input objects where a given pre-determined concept is expected to be found.

In the pipeline 400, the user is further provided with the location of the given portion of the input object 210. The user may intervene through the user interface 106 to and adjust said location in the input object 210. A modified portion of the input object 210 is thus generated based on instructions received from the user through the user interface 106, the modified portion being associated with a modified location in the input object, the modified location being different from the initial location of the given portion determined by the LLN 430.

The DSN 230 of the pipeline 400 further includes a Concept Learning Network (CLN) 435 receiving the modified location of the given portion. It should be noted that, in the scenario where the user does not modify the location of the given portion through the user interface 106, the initial location of the given portion determined by the LLN 430 is transmitted to the CLN 435 instead of the modified location of the given portion.

It can be said that the LLN 430 does not learn the concepts themselves, but rather specific parts of the input object 210 (e.g. of an image file) related to the concepts. For example, in a scenario where the pre-determined concepts are wing colour, wing shape and wing pattern for bird species classification, it might be desirable to further narrow the detection to the bird's wing as opposed to the whole bird itself. Users can then modify the concept part locations and values before using those as inputs to the CLN 435.

The CLN 435 further determines the pre-determined concepts in the location or the modified of the given portion, and numerical values attributed to the pre-determined concepts. The CLN 435 transmits its output to the user interface 106, said output including a human-interpretable output, such that the user can again intervene if necessary to update the numerical values before being used to generate the prediction value 250. The user may thus intervene a plurality of times in the embodiment of FIG. 4.

The PSN 240 further generates the prediction value 250 based on the human-interpretable output (e.g. information about the pre-determined concepts) that may have been modified by the user, and the corresponding given portion of the input object 210 (e.g. locations of the pre-determined concepts), that may also have been modified by the user.

Although the examples set forth in the present disclosure relate to the input object 210 being an image file, the present technology may be applied to different types of input objects. Indeed, text files may be used as inputs for, for example, natural language processing. Reviews and comments associated with an item (e.g. a movie or a product) may be used as inputs. By relating concepts such as “quality” or “fast delivery” to the locations in the sentences/paragraphs in which those concepts are found, users can double-check accuracy of the reviews and comments. Audio files may also be used as inputs. For example, microphones could be set up in a natural habitat to listen for bird sounds of endangered species. Certain audio concepts in the audio files captured by the microphones can be identified, and those time points can be played to determine the species of the birds. Video files may also be used as inputs. For example, finding inappropriate themes in movies so that particular scenes can be removed for viewing by general audiences. An additional example relates to parent guides so they are aware of the timepoints in which “frightening scenes” or “adult themes” appear in the movie and can skip portions of the video file if needed. The input object may also include multiple inputs. In other words, the input object 210 may be a dataset. For example, in the medical field, demographic information on the patients (age, race, gender, history of smoking, etc.) may be included with other types of information, such as images, to better predict a diagnosis or prognosis.

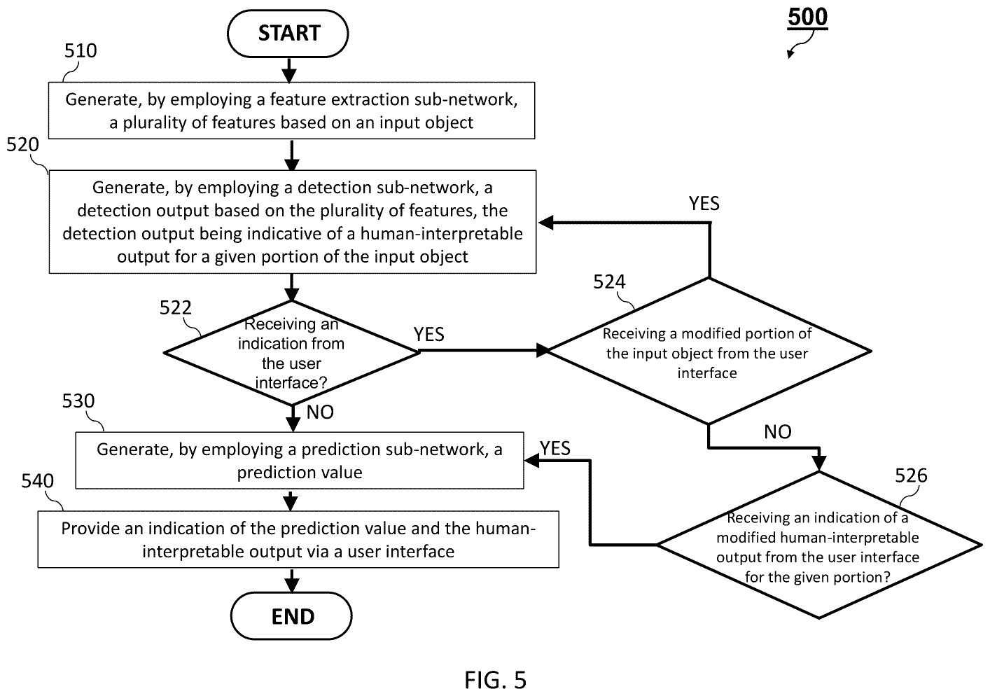

FIG. 5 is a flow diagram of a method 500 for generating a prediction value of a Neural Network (NN) according to some embodiments of the present technology. In one or more aspects, the method 500 or one or more steps thereof may be performed by a processor or a computer system, such as the computing unit 110. The method 500 or one or more steps thereof may be embodied in computer-executable instructions that are stored in a computer-readable medium, such as a non-transitory mass storage device, loaded into memory and executed by a CPU. Some steps or portions of steps in the flow diagram may be omitted or changed in order.

The method 500 includes, at operation 510, generating, by the processor employing a feature extraction sub-network such as the FESN 220, a plurality of features based on an input object. The input object may be the aforementioned input object 210 or may have similar features. For example and without limitation, the input object may be an image file, an audio file, or a video file. In this embodiment, the feature extraction sub-network is a Convolutional Neural Network (CNN).

The method 500 includes, at operation 520, generating, by the processor employing a detection sub-network, a detection output (e.g. detection output 235) based on the plurality of features. The detection sub-network may be the DSN 230 or may have similar features. In this embodiment, the detection sub-network has been trained to generate the detection output indicative of a human-interpretable output for a given portion of the input object. The human-interpretable output includes information about one or more human understandable pre-determined concepts, and information about one or more locations of said pre-determined concepts on the input object. It can be said that the detection sub-network maps the features into the one or more concepts that are human-interpretable.

In some embodiments, the method 500 further includes, at operation 522, receiving, by the processor, an indication from the user interface. Said indication may be entered by the user and include information about a desire of the user to adjust the portion of the input object or the human-interpretable output. In response to, at operation 524, receiving a modified portion of the input object from the user interface, the modified portion being different from the given portion, the method 500 includes generating, by the processor employing the detection sub-network, a modified detection output being indicative of an other human-interpretable output for the modified portion, the other human-interpretable output being different from the human-interpretable output. In use, the user may provide user instructions to the processor through the user interface, the user instructions being indicative of a desire of the user to modify a location of the identified portion of the input object. For example, the user may adjust a position of a bounding box associated with a pre-determined concept determined by the processor. It can be said that operation 520 is executed a second time to generate the modified detection output based on the indication of a modified portion. In use, the detection sub-network may generate the modified detection output based on the user instructions received through the user interface, the modified detection output being indicative of an other human-interpretable output for the modified portion, the other human-interpretable output being different from the human-interpretable output. This loop of operations may be executed any number of times until the user is satisfied with the modified detection output.

In some embodiments, the method 500 further includes, at operation 526, receiving, by the processor, an indication of a modified human-interpretable output from the user interface for the given portion. In the same or other embodiments, the detection sub-network includes a Location Learning Network (LLN) and a Concept Learning Network (CLN). The LLN and the CLN may be implemented as the LLN 430 and the CLN 435 respectively or have similar features. In these embodiments, the processor generates the detection output by determining, employing the LLN, a location of the given portion in the input object based on the plurality of features, and generating, by employing the CLN, the human-interpretable output based on the location of the given portion and the plurality of features.

In use, the processor may receive an indication of a modified portion of the input object from the user interface, the modified portion being associated with a modified location in the input object, the modified location being different from the location of the given portion. The processor may further generate, by employing the CLN, an other human-interpretable output based on the modified portion and the plurality of features. Said other human-interpretable output and the modified portion may further be transmitted to the prediction sub-network such that the processor may generate another prediction value based on the other human-interpretable output and the modified portion.

The method 500 includes, at operation 530, generating, by the processor employing a prediction sub-network, the prediction value based on the human-interpretable output and the given portion of the input object. The prediction sub-network may be the PSN 240 or have similar features. In this embodiment, the prediction sub-network is at least one of a classification sub-network and a regression sub-network.

In scenarios where the detection sub-network has generated a modified detection output, the processor employs, at operation 530, an other prediction value based on the other human-interpretable output and the modified portion.

In scenarios where an indication of a modified human-interpretable output has been received at operation 526, the processor employs the prediction sub-network to generate an other prediction value based on the modified human-interpretable output and the portion of the input object.

In these embodiments, the method 500 further includes the prediction sub-network is further employed at operation 530 by the processor to generate another prediction value based on the other human-interpretable output and the modified portion. An indication of the other prediction value and of the other human-interpretable output may be provided to the user through the user interface at operation 540. The user may thus intervene in the inference process of the neural network by being provided with human-interpretable output related to the prediction value.

The method 500 includes, at operation 540, providing, by the processor, an indication of the prediction value and the human-interpretable output via a user interface. The user interface may be the user interface 106 or have similar features.

In scenarios where the detection sub-network has generated a modified detection output, the processor provides, at operation 540, an indication of the other prediction value and of the other human-interpretable output to the user interface.

In scenarios where an indication of a modified human-interpretable output has been received at operation 526, the processor provides, at operation 540, an indication of the other prediction value and of the modified human-interpretable output to the user interface.

It can be said that the human-interpretable output enables a user of the processor to evaluate accuracy of the prediction value.

In some embodiments, the method 500 further includes providing an indication of the given portion of the input object to the user through the user interface 106, in addition to the prediction value and the human-interpretable output. Said indication may be, for example and without limitation, a bounding box containing the pre-determined concept located in the given portion of the input object.

In some embodiments, the method 500 further includes generating, by the processor employing an other prediction sub-network, an other prediction value based on the plurality of features. The other prediction sub-network may be the PSN 340 or have similar features. Said generation of the other prediction value may be for example executed subsequent to operation 510. In these embodiments, the method 500 further includes providing, by the processor, an indication of the other prediction value to the user interface, in addition to the prediction value and the human-interpretable output.

While the above-described implementations have been described and shown with reference to particular steps performed in a particular order, it will be understood that these steps may be combined, sub-divided, or re-ordered without departing from the teachings of the present technology. At least some of the steps may be executed in parallel or in series. Accordingly, the order and grouping of the steps is not a limitation of the present technology.

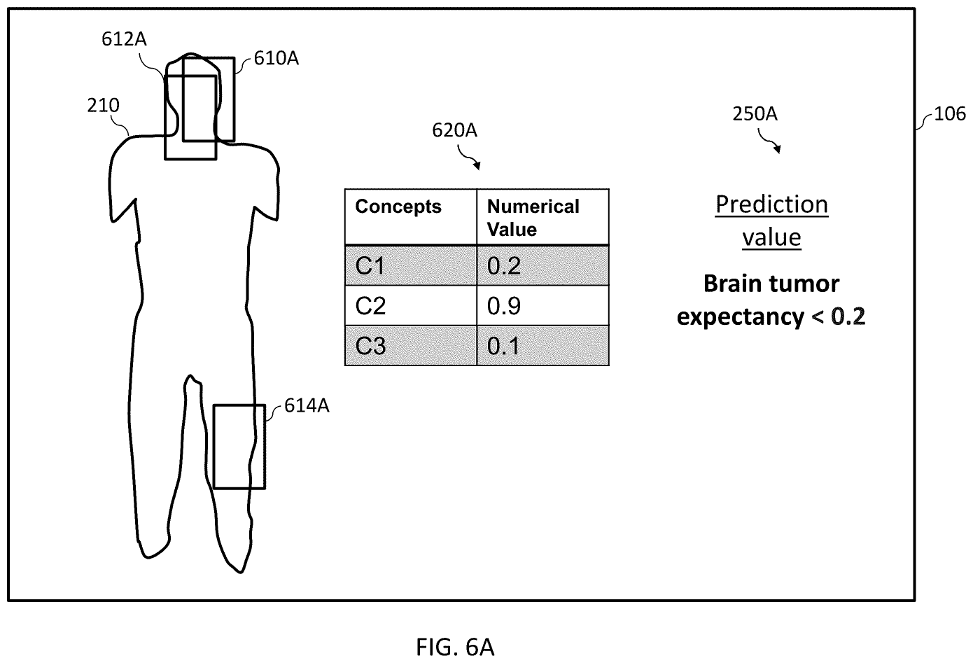

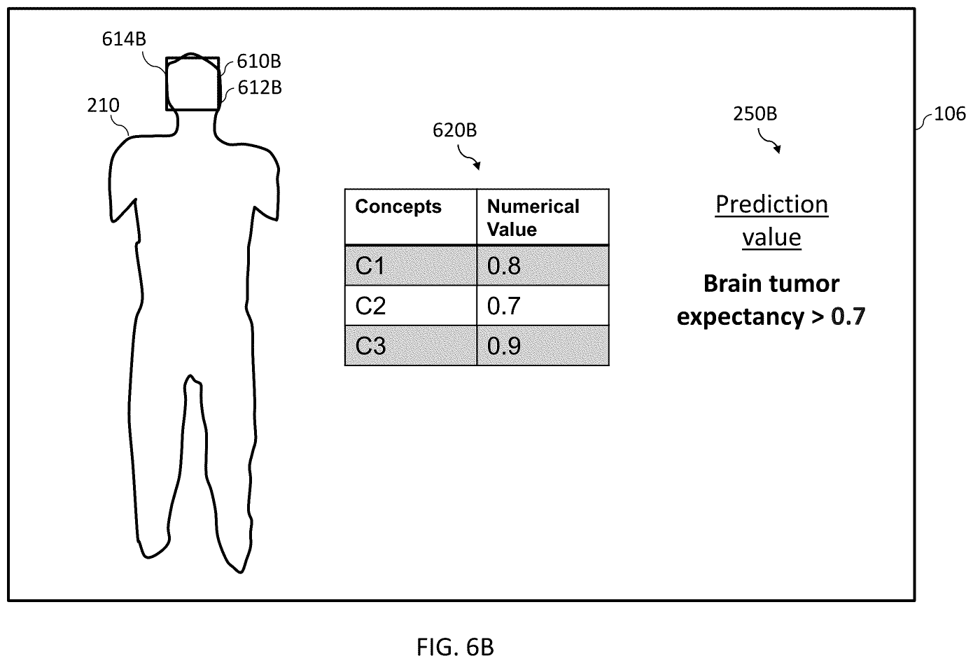

FIG. 6A depicts a rendering of the user interface 106 for an illustrative use case scenario of the present technology. In this use case scenario, the input object 210 provided to the user device 100 is a Magnetic resonance imaging (MRI) image of human body. The MLA executed by the user device 100 on the input object 210 has been trained to determine presence of a brain tumor based on an MRI image of the body of a patient. Any one of the pipeline ″00, /)), or $)) may be used to generate data provided on the user interface 106 at FIG. 6A.

In this embodiment, the user device 100 provides the user with, through the user interface 106, a representation of the input object 210 and portions 610A, 612A and 614A of the input object 210, the Detection Sub-Network (DSN) 230 having been trained such that a detection output of the DSN 230 is indicative of a human-interpretable output for a given portion of the input object 210. Portions 610A, 612A and 614A are represented as bounding boxes to identify which portion of the input object they pertain.

In this embodiment, a human-interpretable output 620A is provided to the user, the human-interpretable output 620A including information about three pre-determined concepts C1, C2 and C3. Each pre-determined concept is associated with one of the portions 610A, 612A, 614A and a numerical value. More specifically, a given pre-determined concept (e.g. C1) has been found by the DSN 230 in the corresponding portion (e.g. portion 610A) of the input object 210, a corresponding numerical value (e.g. 0.2) being indicative of a level of presence of the pre-determined concept in said portion. In the illustrative example of FIG. 6A, the numerical value of the pre-determined concept C1 is 0.2, the numerical value of the pre-determined concept C2 is 0.9 and the numerical value of the pre-determined concept C3 is 0.1. The numerical value in the human-interpretable output 620A and the portions 610A, 612A, 614A are included in the detection output of the DSN 230.

The user device 100 also provide, through the user interface 106, a prediction value 250A. In this embodiment, the prediction value 250A is generated by the Prediction Sub-Network (PSN) 240 based on the detection output.

In the illustrative embodiment of FIG. 6A, the prediction value 250A indicates that the patient is not likely to have a brain tumor, given that the prediction value 250B indicative of a brain tumor expectancy determined by the PSN 240 is below 0.2 (on a scale of 1 for example). However, it can be seen that portion 614A associated with pre-determined concept C3 is located on a leg of the MRI-imaged body of the patient, which may be considered as erroneous location of the pre-determined concept C3. The user (e.g. a neurologist) may thus conclude that the prediction value 250A should not be taken into consideration, given that the prediction value 250A has been generated based on erroneous entries.

With reference to FIG. 6B, the user may modify one or more of the portions 610A, 612A, 614B by transmitting adjustment instructions to the user device 100. For example, said adjustment instructions may be sent through a touchscreen of the user interface 106 enabling the user to adjust a position and size of the bounding boxes associated with the portions 610A, 612A, and 614B. FIG. 6B depicts the user interface 106 after the user has adjusted the three portions 610A, 612A, 614A, thereby generating modified portions 610B, 612B, 614B respectively. As can be seen on FIG. 6B, the modified portions 610B, 612B, 614B are located on a head-portion of the MRI-imaged body, which is a more coherent portion of the MRI-imaged body in the context of determining presence of brain tumor than leg portions.

In this embodiment, the adjustment instructions, i.e. the modified sizes and positions of the modified portions 610B, 612B, 614B, are transmitted back to the DSN 230. The DSN 230 further generates a modified detection output based on the modified portions 610B, 612B, 614B, the modified detection output including a modified human-interpretable output 620B. In the illustrative example, the numerical values for each pre-determined concept have changed due to modification of the sizes and locations of the portions associated thereto. For example, based on the modified portions 610B, 612B, 614B, the modified numerical value of the pre-determined concept C1 is 0.8, the modified numerical value of the pre-determined concept C2 is 0.7 and the modified numerical value of the pre-determined concept C3 is 0.9.

The PSN 240 further determines a modified prediction value 250B based on the modified detection output. In this illustrative example, the prediction value 250B indicates that the patient is likely to have a brain tumor, given that the prediction value 250B indicative of a brain tumor expectancy determined by the PSN 240 is above 0.7 (on a scale of 1 for example).

In this illustrative example, the user is thus enabled with the possibility to interact with, manage and/or monitor the inference process of the MLA.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A method of generating a prediction value of a Neural Network (NN), the method executable by a processor, the method comprising:
generating, by the processor employing a feature extraction sub-network, a plurality of features based on an input object;
generating, by the processor employing a detection sub-network, a detection output based on the plurality of features,
the detection sub-network having been trained to generate the detection output indicative of a human-interpretable output for a given portion of the input object;
generating, by the processor employing a prediction sub-network, the prediction value based on the human-interpretable output and the given portion of the input object; and
providing, by the processor, an indication of the prediction value and the human-interpretable output via a user interface.

2. The method of claim 1, wherein the method further comprises:
providing, by the processor, an indication of the given portion of the input object to the user interface, in addition to the prediction value and the human-interpretable output.

3. The method of claim 1, wherein the method further comprises:
generating, by the processor employing an other prediction sub-network, an other prediction value based on the plurality of features; and
providing, by the processor, an indication of the other prediction value to the user interface, in addition to the prediction value and the human-interpretable output.

4. The method of claim 1, wherein the feature extracting sub-network is a Convolutional Neural Network (CNN).

5. The method of claim 1, wherein the prediction sub-network is at least one of a classification sub-network and a regression sub-network.

6. The method of claim 1, wherein the method further comprises:
receiving, by the processor, an indication of a modified portion of the input object from the user interface, the modified portion being different from the given portion;
generating, by the processor employing the detection sub-network, a modified detection output being indicative of an other human-interpretable output for the modified portion, the other human-interpretable output being different from the human-interpretable output;
generating, by the processor employing the prediction sub-network, an other prediction value based on the other human-interpretable output and the modified portion; and
providing, by the processor, an indication of the other prediction value and of the other human-interpretable output to the user interface.

7. The method of claim 1, wherein the method further comprises:
receiving, by the processor, an indication of a modified human-interpretable output from the user interface for the given portion;
generating, by the processor employing the prediction sub-network, an other prediction value based on the modified human-interpretable output and the portion of the input object; and
providing, by the processor, an indication of the other prediction value and of the modified human-interpretable output to the user interface.

8. The method of claim 1, wherein the detection sub-network includes a Location Learning Network (LLN) and a Concept Learning Network (CLN), and wherein the generating the detection output comprises:
determining, by the processor employing the LLN, a location of the given portion in the input object based on the plurality of features; and
generating, by the processor employing the CLN, the human-interpretable output based on the location of the given portion and the plurality of features.

9. The method of claim 8, wherein the method further comprises:
receiving, by the processor, an indication of a modified portion of the input object from the user interface, the modified portion being associated with a modified location in the input object, the modified location being different from the location of the given portion;
generating, by the processor employing the CLN, an other human-interpretable output based on the modified portion and the plurality of features;
generating, by the processor employing the prediction sub-network, an other prediction value based on the other human-interpretable output and the modified portion; and
providing, by the processor, an indication of the other prediction value and of the other human-interpretable output to the user interface.

10. The method of claim 1, wherein the input object is at least one of: an image file, an audio file, and a video file.

11. The method of claim 1, wherein the human-interpretable output is for enabling a user of the processor to evaluate accuracy of the prediction value.

12. A system for generating a prediction value of a Neural Network (NN), the system comprising a processor and a memory, the memory comprising instructions which, upon being executed by the processor, cause the processor to:
generate, by employing a feature extraction sub-network, a plurality of features based on an input object;
generate, by employing a detection sub-network, a detection output based on the plurality of features,
the detection sub-network having been trained to generate the detection output indicative of a human-interpretable output for a given portion of the input object;
generate, by employing a prediction sub-network, the prediction value based on the human-interpretable output and the given portion of the input object; and
provide an indication of the prediction value and the human-interpretable output via a user interface.

13. The system of claim 12, wherein the processor is further configured to:
providing, by the processor, an indication of the given portion of the input object to the user interface, in addition to the prediction value and the human-interpretable output.

14. The system of claim 12, wherein the processor is further configured to:
generating, by the processor employing an other prediction sub-network, an other prediction value based on the plurality of features; and
providing, by the processor, an indication of the other prediction value to the user interface, in addition to the prediction value and the human-interpretable output.

15. The system of claim 12, wherein the feature extracting sub-network is a Convolutional Neural Network (CNN).

16. The system of claim 12, wherein the prediction sub-network is at least one of a classification sub-network and a regression sub-network.

17. The system of claim 12, wherein the processor is further configured to:
receive an indication of a modified portion of the input object from the user interface, the modified portion being different from the given portion;
generate, by employing the detection sub-network, a modified detection output being indicative of an other human-interpretable output for the modified portion, the other human-interpretable output being different from the human-interpretable output;
generate, by employing the prediction sub-network, an other prediction value based on the other human-interpretable output and the modified portion; and
provide an indication of the other prediction value and of the other human-interpretable output to the user interface.

18. The system of claim 12, wherein the processor is further configured to:
receiving an indication of a modified human-interpretable output from the user interface for the given portion;
generate, by employing the prediction sub-network, an other prediction value based on the modified human-interpretable output and the portion of the input object; and
provide an indication of the other prediction value and of the modified human-interpretable output to the user interface.

19. The system of claim 12, wherein the detection sub-network includes a Location Learning Network (LLN) and a Concept Learning Network (CLN), and the processor is further configured to, in order to generate the detection output:
determine, by employing the LLN, a location of the given portion in the input object based on the plurality of features; and
generate, by employing the CLN, the human-interpretable output based on the location of the given portion and the plurality of features.

20. The system of claim 19, wherein the processor is further configured to:
receive an indication of a modified portion of the input object from the user interface, the modified portion being associated with a modified location in the input object, the modified location being different from the location of the given portion;
generate, by employing the CLN, an other human-interpretable output based on the modified portion and the plurality of features;
generate, by employing the prediction sub-network, an other prediction value based on the other human-interpretable output and the modified portion; and
provide an indication of the other prediction value and of the other human-interpretable output to the user interface.

21. The system of claim 12, wherein the input object is at least one of: an image file, an audio file, and a video file.

22. The system of claim 12, wherein the human-interpretable output is for enabling a user of the processor to evaluate accuracy of the prediction value.
